(19) United States
(12) Patent Application Publication
(10) Pub. No.: US 2026/0091280 A1
(43) Pub. Date: Apr. 2, 2026

(54) PORTABLE GOLF CLUB WASHING DEVICE

(71) Applicant: Bradley Allen Mathiowetz, Nashville, TN (US)

(72) Inventor: Bradley Allen Mathiowetz, Nashville, TN (US)

(21) Appl. No.: 19/347,320

(22) Filed: Oct. 1, 2025

Related U.S. Application Data
(60) Provisional application No. 63/701,620, filed on Oct. 1, 2024.

(51) Int. Cl. A63B 57/60; B08B 1/12; B08B 1/34; B08B 3/02; B08B 3/14

(52) U.S. Cl. CPC A63B 57/60; B08B 1/12; B08B 1/34; B08B 3/02; A63B 2057/605; B08B 3/14

(57) ABSTRACT

A portable golf club washing device is provided, featuring a housing with a lid that includes top openings for receiving a golf club head and shaft. The device includes a pump, a flow channel surrounding the housing's interior perimeter, a cradle for supporting the golf club head, and a bracket for holding the club shaft. When the lid is coupled to the housing, a cleaning interior is created for efficiently washing golf clubs.

### FIELD OF THE DISCLOSURE

The present disclosure relates generally to work portable washing devices, and more particularly to methods and devices for automated cleaning of golf clubs.

### BACKGROUND

Previous approaches to cleaning golf clubs have typically involved manual scrubbing with a brush or cloth, which can be time-consuming and labor-intensive. Some existing devices for cleaning golf clubs may include a water source and a brush or bristle mechanism for scrubbing the club head, but these devices often lack portability and may not provide a comprehensive cleaning solution for both the club head and shaft. Additionally, some conventional golf club cleaning devices may not effectively remove dirt, grass, and debris from the grooves of the club head, impacting the performance of the golf club during play.

Other known golf club cleaning devices may incorporate a water pump system to deliver water for cleaning, but these devices may lack a dedicated flow channel to efficiently direct the water around the club head and shaft for thorough cleaning. Furthermore, existing portable golf club cleaning devices may not offer a secure cradle for holding the club head in place during the cleaning process, leading to potential slippage or instability during use. The lack of a bracket to retain the golf club shaft securely may also result in inconvenience and inefficiency when cleaning multiple clubs consecutively.

In light of the limitations of current golf club cleaning devices, there remains a need for an improved portable golf club washing device that provides a convenient, efficient, and thorough cleaning solution for both the club head and shaft. However, none of these approaches have provided a comprehensive solution that combines the features described in this disclosure.

### BRIEF SUMMARY

The current disclosure provides an enhancement to conventional systems, at least in part by introducing a novel method and system for a portable and automated cleaning device for cleaning golf clubs.

According to an aspect of the present disclosure, a portable golf club washing device is provided. The device includes a housing. The device includes a housing lid reversibly coupled to a top portion of the housing and further including at least one top opening configured to receive a golf club head and a portion of a golf club shaft. The device includes a pump. The device includes a flow channel including an inlet in fluid communication with the pump and an outlet, the flow channel arranged around at least a portion of an interior perimeter of the housing. The device includes a cradle configured to support the golf club head. The device includes a bracket configured to releasably retain the portion of the golf club shaft. The housing lid reversibly coupled to the housing together forms a cleaning interior.

According to other aspects of the present disclosure, the portable golf club washing device may include one or more of the following features. The device may further include at least one pair of rotatable mounting brackets arranged at opposing interior sidewalls of the housing. The device may further include a rotary brush including an elongate member, opposing ends of the elongate member configured to operatively engage the at least one pair of rotatable mounting brackets. The device may further include a motor operatively connected to the at least one pair of rotatable mounting brackets and configured to rotate the at least one pair of rotatable mounting brackets. The device may further include a user input interface operatively connected to the pump and configured to control an action of the pump. A user input interface may be operatively connected to the motor and configured to control an action of the motor. The pump may include an inlet arranged at a lower portion of an interior of the housing, wherein at least an interior floor and a portion of interior sidewalls of the housing are configured to retain a volume of fluid. One of the interior sidewalls or the interior floor of the housing may include a drain configured to release fluid from an interior of the housing to an exterior of the housing. The cradle may further include an array of cradles. The bracket may further include an array of brackets associated with the array of cradles. The at least one pair of rotatable mounting brackets and the rotary brush may be arranged between an adjacent pair of cradles of the array of cradles. The flow channel may further include a fluid conduit. The housing may further include a detachable housing base.

In some aspects, the techniques described herein relate to a portable golf club washing device, including: a housing; a housing lid reversibly coupled to a top portion of the housing and further including at least one top opening configured to receive a golf club head and a portion of a golf club shaft; a pump; a flow channel including an inlet in fluid communication with the pump and an outlet, the flow channel arranged around at least a portion of an interior perimeter of the housing; a cradle configured to support the golf club head; and a bracket configured to releasably retain the portion of the golf club shaft; wherein the housing lid reversibly coupled to the housing together forms a cleaning interior.

In some aspects, the techniques described herein relate to a portable golf club washing device, further including: at least one pair of rotatable mounting brackets arranged at opposing interior sidewalls of the housing; a rotary brush including an elongate member, opposing ends of the elongate member configured to operatively engage the at least one pair of rotatable mounting brackets; and a motor operatively connected to the at least one pair of rotatable mounting brackets and configured to rotate the at least one pair of rotatable mounting brackets.

In some aspects, the techniques described herein relate to a portable golf club washing device, further including: a user input interface operatively connected to the pump and configured to control an action of the pump.

In some aspects, the techniques described herein relate to a portable golf club washing device, wherein: a user input interface operatively connected to the motor and configured to control an action of the motor.

In some aspects, the techniques described herein relate to a portable golf club washing device, wherein: the pump includes an inlet arranged at a lower portion of an interior of the housing; wherein at least an interior floor and a portion of interior sidewalls of the housing are configured to retain a volume of fluid.

In some aspects, the techniques described herein relate to a portable golf club washing device, wherein: one of the interior sidewalls or the interior floor of the housing includes a drain configured to release fluid from an interior of the housing to an exterior of the housing.

In some aspects, the techniques described herein relate to a portable golf club washing device, wherein: the cradle further includes an array of cradles; the bracket further includes an array of brackets associated with the array of cradles; and the at least one pair of rotatable mounting brackets and the rotary brush are arranged between an adjacent pair of cradles of the array of cradles.

In some aspects, the techniques described herein relate to a portable golf club washing device, wherein: the flow channel further includes a fluid conduit.

In some aspects, the techniques described herein relate to a portable golf club washing device, wherein: the housing further includes a detachable housing base.

According to another aspect of the present disclosure, a method of using a portable golf club washing device is provided. The method includes providing the portable golf club washing device, including a housing, a housing lid with a top opening, a cradle and a bracket corresponding to the cradle within the housing, a rotatable brush arranged in an operational range of the cradle and the bracket, a motor operatively connected to the rotatable brush, and a pump in fluid communication with a flow channel. The method includes inserting a golf club head and a portion of a golf club shaft into the top opening. The method includes resting the golf club head on the cradle. The method includes engaging the portion of the golf club shaft with the bracket.

According to other aspects of the present disclosure, the method may include one or more of the following features. The method may further include providing a fluid in the housing. The method may further include initiating, through a user input interface operatively connected to the pump, a flow of the fluid through the pump and the flow channel. The method may further include initiating, through a user input interface operatively connected to the motor, a rotation of the rotatable brush.

In some aspects, the techniques described herein relate to a method of using a portable golf club washing device, including: providing the portable golf club washing device, including a housing, a housing lid with a top opening, a cradle and a bracket corresponding to the cradle within the housing, a rotatable brush arranged in an operational range of the cradle and the bracket, a motor operatively connected to the rotatable brush, and a pump in fluid communication with a flow channel; inserting a golf club head and a portion of a golf club shaft into the top opening; resting the golf club head on the cradle; and engaging the portion of the golf club shaft with the bracket.

In some aspects, the techniques described herein relate to a method, further including: providing a fluid in the housing; and initiating, through a user input interface operatively connected to the pump, a flow of the fluid through the pump and the flow channel.

In some aspects, the techniques described herein relate to a method, further including: initiating, through a user input interface operatively connected to the motor, a rotation of the rotatable brush.

According to another aspect of the present disclosure, a portable washing apparatus is provided. The apparatus includes a housing. The apparatus includes a housing lid reversibly coupled to a top portion of the housing and further including at least one top opening configured to receive an item to be washed. The apparatus includes a pump. The apparatus includes a flow channel including an inlet in fluid communication with the pump and an outlet, the flow channel arranged around at least a portion of an interior perimeter of the housing. The apparatus includes a support structure configured to support the item to be washed. The apparatus includes a retention mechanism configured to releasably retain a portion of the item to be washed. The housing lid reversibly coupled to the housing together forms a cleaning interior.

According to other aspects of the present disclosure, the portable washing apparatus may include one or more of the following features. The apparatus may further include at least one pair of rotatable mounting brackets arranged at opposing interior sidewalls of the housing. The apparatus may further include a rotary brush including an elongate member, opposing ends of the elongate member configured to operatively engage the at least one pair of rotatable mounting brackets. The apparatus may further include a motor operatively connected to the at least one pair of rotatable mounting brackets and configured to rotate the at least one pair of rotatable mounting brackets. The apparatus may further include a user input interface operatively connected to the pump and configured to control an action of the pump. A user input interface may be operatively connected to the motor and configured to control an action of the motor. The pump may include an inlet arranged at a lower portion of an interior of the housing, wherein at least an interior floor and a portion of interior sidewalls of the housing are configured to retain a volume of fluid. One of the interior sidewalls or the interior floor of the housing may include a drain configured to release fluid from an interior of the housing to an exterior of the housing. The support structure may further include an array of support structures. The retention mechanism may further include an array of retention mechanisms associated with the array of support structures. The at least one pair of rotatable mounting brackets and the rotary brush may be arranged between an adjacent pair of support structures of the array of support structures. The flow channel may further include a fluid conduit.

Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 depicts an exploded perspective view of a portable golf club washing device, according to aspects of the present disclosure.

FIGS. 2A and 2B depict top views of different housing lid configurations, according to aspects of the present disclosure.

FIG. 3 depicts a perspective view of an interior of the portable golf club washing device of FIG. 1, according to aspects of the present disclosure.

FIG. 4 depicts a partial view of the portable golf club washing device of FIG. 1, according to aspects of the present disclosure.

FIG. 5 depicts a flowchart of an exemplary method for cleaning golf clubs, according to aspects of the present disclosure.

FIG. 6 depicts a perspective view of exemplary inserts for the portable washing device, according to aspects of the present disclosure.

FIG. 7 depicts a perspective view of the portable washing device of FIG. 1, according to aspects of the present disclosure.

FIG. 8 depicts a perspective view of the portable washing device with a basket assembly, according to aspects of the present disclosure.

### DETAILED DESCRIPTION

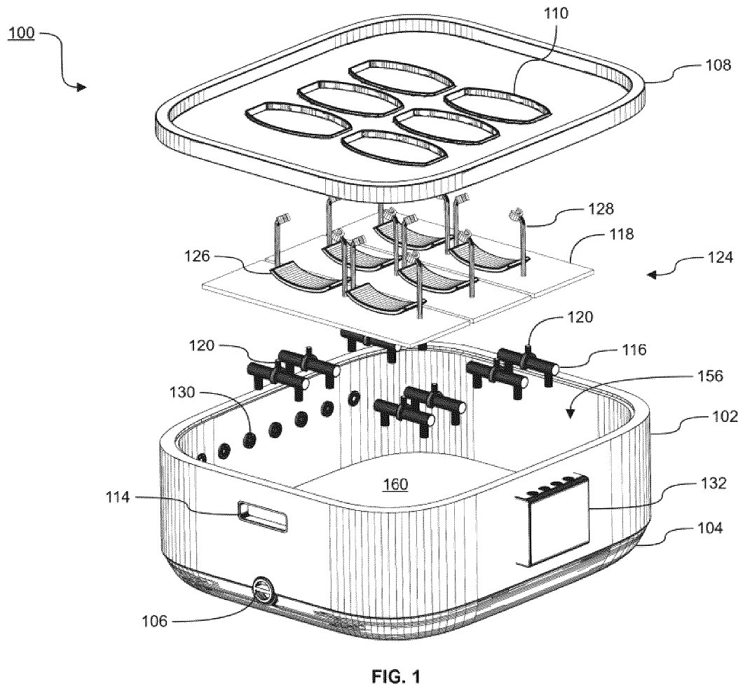

Referring now to FIGS. 1-8, various embodiments may now be described of a portable washing device that provides automated cleaning of golf clubs through a combination of fluid circulation and rotary brush mechanisms and methods of operation thereof.

FIG. 1 depicts an exploded perspective view of a portable golf club washing device 100 according to the present disclosure. In some aspects, the portable golf club washing device 100 provides a lightweight and portable device designed to allow a user to clean golf clubs, among other objects, in a mobile fashion with little setup or configuration required. The portable golf club washing device 100 includes a housing 102 forming the general structure defining the interior and exterior of the portable golf club washing device 100.

The housing 102 may include a housing base 104 forming a bottom of the housing 102. In some aspects, the housing base 104 may be integrally formed with the housing 102 such that the housing 102 and the housing base 104 for a unitary structure. In other aspects, the housing base 104 may be provided as a detachable component of the housing 102 and may be readily removable from the housing 102. The housing base 104 may be removably coupled to the housing 102 by various structures, including various snap fit, tongue-and-groove, or other equivalent structures formed as part of either the housing 102, the housing base 104 or both. Where the housing base 104 is removably coupled to the housing 102, the fit between the housing base 104 and the housing 102 provides a water-tight seal such that liquid contained within the housing 102 and the housing base 104 does not leak out the seal between the housing 102 and the housing base 104 when the two are coupled. This water-tight seal may be facilitated by various structures, including gaskets, rubber lining, or portions of the housing 102 and the housing base 104 at the seal between the two that provides for a water-tight seal.

In some aspects, the housing 102 may further include a drain 106. In some aspects, the housing base 104 may include the drain 106. In other aspects, the drain 106 may be formed at an intersection between the housing 102 and the housing base 104.

The drain 106 may include a drain plug removably provided in the drain 106. The drain 106 may provide a channel through which fluid may flow from an inside of the housing 102 to an outside of the housing 102.

Various types of the drain 106 may be provided, including the drain 106 with a valve instead of a removable plug or in addition to a removable plug, or other structures to control a rate of flow of fluid through the drain 106. In some aspects, the drain 106 may include a drain valve operatively connected to the controller 132 and configured to be selectively controlled through the user input interface 148. The drain valve may provide automated or user-controlled selective removal of fluid from the cleaning interior 156 of the portable golf club washing device 100. In an exemplary aspect, the user input interface 148 may include a drain control button or setting that allows a user to initiate drainage of the cleaning interior 156 after completion of a cleaning cycle. The controller 132 may be programmed to automatically open the drain valve at predetermined intervals or upon completion of specific cleaning protocols, thereby facilitating efficient fluid management within the housing 102 and housing base 104.

The portable golf club washing device 100 may also include a housing lid 108, that together with the housing 102 and the housing base 104 if present forms a cleaning interior 156 of the portable golf club washing device 100. In some aspects, the housing lid 108 may be reversibly coupled to a top portion of the housing 102. In some aspects, the housing lid 108 may be integrally formed with the housing 102. The reversible coupling between the housing 102 and the housing lid 108 may be the same as or substantially similar the sealing between the housing 102 and the housing base 104 as disclosed above. The housing lid 108 may include at least one top opening 110 configured to receive a golf club head and a portion of a golf club shaft. In some aspects, the at least one top opening 110 includes an array of top openings. According to the present disclosure, the at least one top opening 110 of the housing lid 108 may be selectable based on the overall size and shape of the portable golf club washing device 100, desired capacity of the portable golf club washing device 100, any golf club that may be cleaned with the portable golf club washing device 100, including different sized and shaped golf clubs, or other considerations that may account for cleaning capacity of the portable golf club washing device 100 and the arrangement of additional structures disclosed herein involved in method of cleaning.

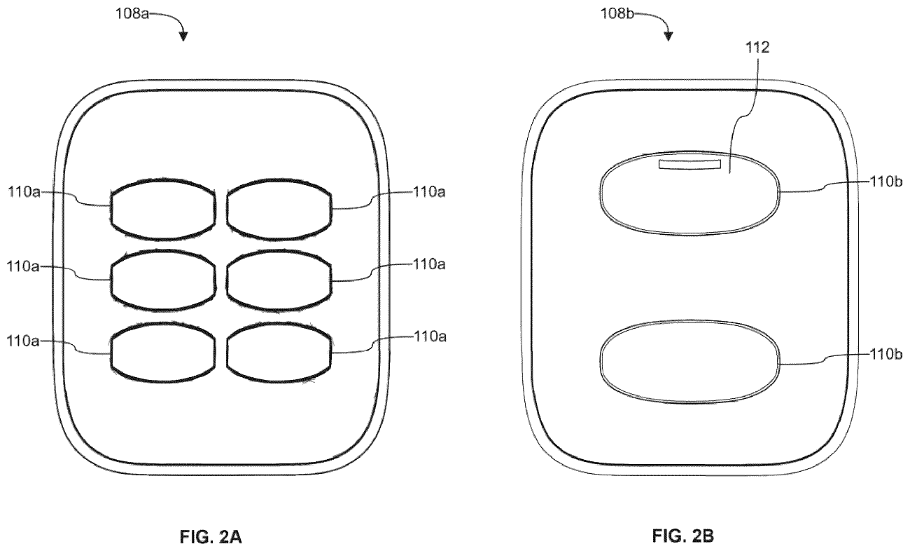

FIGS. 2A and 2B depict an exemplary aspect of the housing lid 108 according to the present disclosure. In some aspects, the housing lid 108 may be provided as a first housing lid 108a, with the at least one top opening 110 of the first housing lid 108a including a first array of top openings 110a. The top openings 110a may be dimensioned to receive any standard golf club or a subset portion of standard golf clubs. In an exemplary aspect, the top openings 110a are dimensioned and spaced to receive at least golf clubs commonly referred to as irons, blade putters, and in some aspects, various golf clubs known as hybrids or woods. The top openings 110a may be provided as simple openings, with or without edge lip structures. In the exemplary first housing lid 108a, the top openings 110a are provided without any type of lids, though the top openings 110a may be provided with closable lid structures if desired. In some aspects, the housing lid 108 may be provided as a second housing lid 108b, with the at least one top opening 110 of the second housing lid 108b including one or more top openings 110b. In the exemplary aspect depicted in FIG. 2B, the one or more top openings 110b may be provided with an accompanying top opening lid 112. The accompanying top opening lid 112 may be movable in a sliding, hinged, or wholly removeable fashion to provide the one or more top openings 110b with both an open position and a closed position. In some aspects, the one or more top openings 110b may be dimensioned differently from the top openings 110a and may be configured to receive different golf club heads and corresponding golf club shafts than those contemplated to be inserted into top openings 110a. In an exemplary aspect, the one or more top openings 110b may be configured to receive drivers, woods, and other golf club heads with larger surface areas. In some aspects, the features of the first housing lid 108a and the second housing lid 108b may be selectively combined to provide a housing lid 108 that includes both an array of top openings 110a and one or more top openings 110b.

In some aspects, the at least one top opening 110 may include a contoured edge configured to releasably retain the golf club shaft when inserted into the portable golf club washing device 100. The contoured edge may include concave contours positioned on opposing sides of the at least one top opening 110, with each concave contour forming a cutout sized to receive and secure an angled golf club shaft. The concave contours may be dimensioned to accommodate various golf club shaft diameters and angles, providing a secure retention mechanism that prevents movement of the golf club shaft during cleaning operations while allowing for easy insertion and removal of the golf club from the portable golf club washing device 100.

Returning to FIG. 1, the housing 102 may further include a handle 114 for ease of gripping and transport. In an exemplary aspect, the housing 102 includes a pair of the handle 114 positioned on opposing exterior surfaces of the housing 102 and formed as inlets with the housing 102 configured to receive portions of a user's fingers and facilitate moving and the portability of the portable golf club washing device 100. In some aspects, the handle 114 may be formed as structures not integral with the housing 102, including a handle 114 that is reversibly coupled to the housing 102 via an attachment mechanism. In some aspects, the attachment mechanism of the handle 114 may be irreversibly coupled to the housing 102.

An interior floor of the housing 102 may be configured to support at least one support 116. In some aspects, the at least one support 116 may be integrally formed with the interior floor of the housing 102, which in some aspects may be formed as a portion of the housing base 104. In other aspects, the at least one support 116 may be free standing and decoupled to the interior floor of the housing 102. In further aspects, the at least one support 116 may be releasably coupled with the interior floor of the housing 102. In some aspects, the at least one support 116 may include an array of the at least one support 116, arranged on the interior floor of the housing 102 in a manner to fully support at least one shelf 118 of an apparatus to be cleaned. In some aspects, the at least one support 116 may be coupled, releasably coupled to, or integrally formed with, the at least one shelf 118 such than an array of the at least one support 116 may be arranged to adequately correspond with the number and position of the at least one shelf 118 provided for the portable golf club washing device 100. In an exemplary aspect, the at least one support 116 may be provided as a bridge support with one or more support legs and a support crossbar either centrally positioned among the one or more support legs or position cantilever or partially cantilever with the one or more support legs.

In some aspects, the portable golf club washing device 100 may further include at least one shelf bracket 120. The at least one shelf bracket 120 may provide releasable coupling between the at least one shelf 118 and the at least one support 116. In some aspects, the at least one shelf bracket 120 may be integrally formed with, or simply affixed to, the at least one shelf 118. Where the at least one shelf 118 includes an array of shelves 118, the at least one support 116, the at least one shelf bracket 120, and one or more of the shelves 118 may correspond with each other. In an exemplary aspect, the at least one shelf bracket 120 may be a clamp, or a C-clamp, that partially encircles a cylindrical at least one support 116. The interaction of the at least one shelf bracket 120 and the at least one support 116 may include clamping brackets, collar clamp, and other interacting structures for ready force coupling. In some aspects, the at least one support 116 and the at least one shelf bracket 120 may be integrally formed together and provide support connection between the at least one shelf 118 and the housing 102.

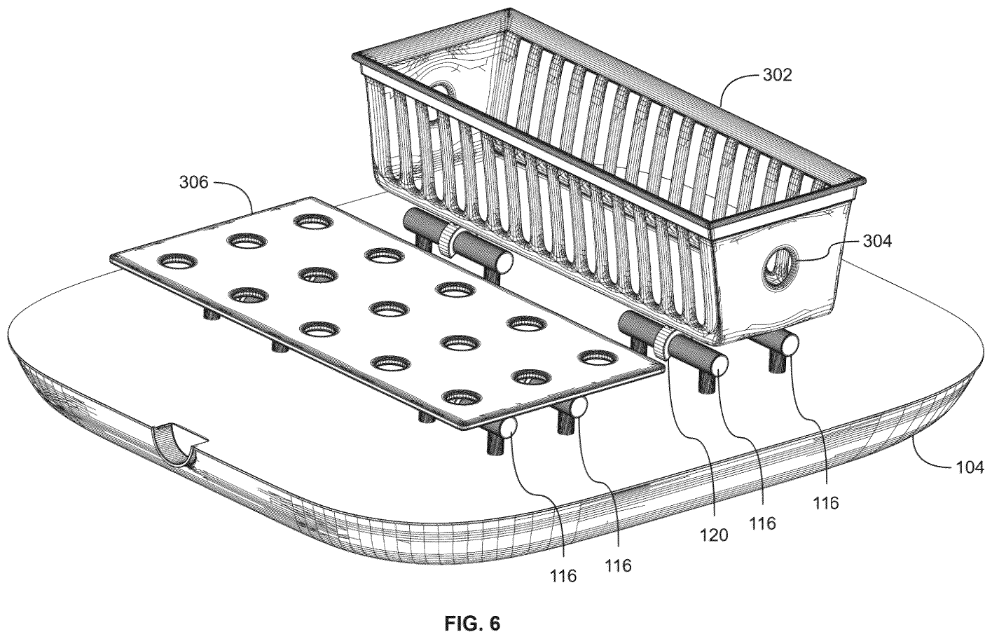

In some aspects, the portable golf club washing device 100 may further include a basket assembly that may be interchangeably used with the shelf assembly 124, as depicted in FIGS. 6-8. The basket assembly may include at least one basket 302 and a utensil tray 306, with the at least one shelf bracket 120 providing releasable coupling between the basket assembly and the at least one support 116. In some aspects, the at least one shelf bracket 120 may be integrally formed with, or simply affixed to, the at least one basket 302 or utensil tray 306. Where the basket assembly includes an array of baskets 302, the at least one support 116, the at least one shelf bracket 120, and one or more of the baskets 302 may correspond with each other. In an exemplary aspect, the at least one shelf bracket 120 associated with the basket assembly may be a clamp, or a C-clamp, that partially encircles a cylindrical at least one support 116. The interaction of the at least one shelf bracket 120 and the at least one support 116 may include clamping brackets, collar clamp, and other interacting structures for ready force coupling. In some aspects, the at least one support 116 and the at least one shelf bracket 120 may be integrally formed together and provide support connection between the basket assembly and the housing 102. The interchangeable nature of the shelf assembly 124 and basket assembly may allow for cleaning of different sized and configurations of items, with each assembly being readily removable and replaceable through the releasable coupling mechanism provided by the at least one shelf bracket 120.

In some aspects, the portable golf club washing device 100 may include a shelf assembly 124. The shelf assembly 124 may provide a support structure for an article to be cleaned with the portable golf club washing device 100. The shelf assembly 124 may include interacting structures, including the at least one shelf 118. The at least one shelf 118 may be formed as a base support structure of the shelf assembly 124, being connected to the at least one shelf bracket 120 and/or at least one support 116. In an exemplary aspect, the at least one shelf 118 is a flat plate surface that further supports a cradle 126 and a shaft bracket 128. In an exemplary aspect, the cradle 126 and the shaft bracket 128 are included in the shelf assembly 124. In other aspects, the cradle 126 and the shaft bracket 128, separately or together, may be removably couplable with the at least one shelf 118, to provide coupling with a golf club head and/or golf club shaft prior to coupling of the cradle 126 and shaft bracket 128 to the at least one shelf 118.

In an exemplary aspect, the cradle 126 is provided to support the golf club head when inserted into the portable golf club washing device 100 and during action of the portable golf club washing device 100. In some aspects, the cradle 126 may be formed by one or more cooperating surfaces to form a concave feature configured to receive the golf club head. In an exemplary aspect, the cradle 126 may be provided as an inward curving surface along a sole, a heel, a face, a back, a toe, a crown, or any combination thereof of the golf club head. In some aspects, the cradle 126 may include varies contours along a contacting surface of the cradle 126 to selectively form to surfaces of various golf club heads. In an additional exemplary aspect, the cradle 126 may be provided as a pair of parallel rounded ridges that resembles the top half of a prolate spheroid cut along the equatorial plane with a central valley running along the longitudinal axis thereof, thus creating the pair of symmetrical parallel rounded ridges. Each of the pair of ridges may be curved, forming symmetrical arcs as they taper slightly towards their ends. In some aspects, the cradle 126 may further include an upward taper of the longitudinal ends to form a generally canoe style cradle. The cradle 126 is preferably formed to prevent movement and rotation of the golf club head when supported by the cradle 126 and the portion of the golf club shaft is releasably retained in the shaft bracket 128.

In some aspects, the cradle 126 may be formed with various materials, including plastics, foam or other suitable cushioning materials, and other materials suitable for supporting golf club heads during cleaning without damaging or otherwise scuffing the surface of the golf club heads. The selection of materials for the cradle 126 may be particularly important given the variety of golf club head materials and finishes that may be encountered, including stainless steel, carbon steel, titanium, aluminum alloys, and various composite materials with specialized coatings or plating. In an exemplary aspect, the cradle 126 may include a soft polymer material such as thermoplastic elastomer (TPE) or silicone rubber that provides sufficient cushioning while maintaining structural integrity during repeated cleaning cycles. The cradle 126 may also incorporate closed-cell foam padding or neoprene inserts that resist water absorption and provide consistent support characteristics even when exposed to cleaning fluids over extended periods. In some aspects, the cradle 126 may include interchangeable cushioning inserts of varying hardness levels to accommodate different golf club head materials, with softer inserts being utilized for delicate finishes such as chrome plating or specialized coatings, and firmer inserts being employed for more robust club head materials. The material selection for the cradle 126 may also consider chemical compatibility with various cleaning agents that may be used in the portable golf club washing device 100, ensuring that the cradle material does not degrade or become compromised when exposed to soaps, detergents, or other cleaning solutions. Additionally, the cradle 126 materials may be selected for their non-abrasive properties and resistance to bacterial growth, facilitating easy cleaning and sanitization of the cradle 126 itself between uses.

The shaft bracket 128 is configured to releasably configured to releasably retain the portion of the golf club shaft. In an exemplary aspect, the shaft bracket 128 includes a base affixed to the at least one shelf 118 and extending upwardly past a range of available dimensions of the golf club head to terminate in a clamp to releasably retain the portion of the golf club shaft. The clamp may include a C-clamp or any other suitable clamp as discussed above regarding the at least one shelf bracket 120. The shaft bracket 128 may be arranged to releasably retain the portion of the golf club shaft at an angle, the angle being selectable based upon the particular portable golf club washing device 100, the arranged structure of the at least one top opening 110 of the housing lid 108, the cradle 126, and other structures of the portable golf club washing device 100 actionable on the golf club head and golf club shaft, including cleaning implements and cleaning fluid. In exemplary aspects, each of the cradle 126 corresponds to one or more of the shaft bracket 128 configured to releasably retain the golf club shaft corresponding to the golf club head supported on the cradle 126. In some aspects, the shaft bracket 128 may be integrated with the at least one top opening 110.

In some aspects, the shaft bracket 128 may be coupled to various internal structures of the portable golf club washing device 100 to provide flexible positioning and secure retention of the golf club shaft during cleaning operations. The shaft bracket 128 may be affixed to an interior underside of the housing lid 108, allowing the shaft bracket 128 to be positioned above the cradle 126 and provide downward retention force on the golf club shaft. In other aspects, the shaft bracket 128 may be mounted to one or more interior sidewalls 164 of the housing 102, providing lateral support and retention of the golf club shaft at various angles relative to the cradle 126. The shaft bracket 128 may also be coupled to the at least one shelf 118, as previously disclosed, or may be integrated with other structural components of the shelf assembly 124. In some cases, the shaft bracket 128 may be mounted to multiple internal structures simultaneously, such as being coupled to both an interior sidewall 164 and the at least one shelf 118, to provide enhanced stability and adjustability for accommodating different golf club configurations. The coupling of the shaft bracket 128 to these various internal structures may be accomplished through releasable fastening mechanisms, allowing for repositioning or removal of the shaft bracket 128 as needed for different cleaning applications or maintenance of the portable golf club washing device 100.

In other aspects of this disclosure, the at least one support 116 may be releasably coupled to at least one shelf bracket 120 of an at least one shelf 118 that supports various cleaning brackets and supports for other articles to be cleaned. In some aspects, the shelf assembly 124 may be configured to support utensils or other objects to be cleaned in a basket assembly. FIGS. 6-8 depict exemplary aspects of the basket assembly according to the present disclosure. The basket assembly may include the at least one support 116 coupled to the housing base 104 as disclosed above, and may further include the at least one shelf bracket 120 providing releasably coupling between the structures of the basket assembly and the at least one support 116. In some aspects, the basket assembly may include at least one basket 302 configured to contain utensils, jewelry, or other objects to be cleaned. The at least one basket 302 may include various slots and openings throughout the bounding sidewalls and/or floor of the at least one basket 302 to provide flow of the fluid through the at least one basket 302 during cleaning. The at least one basket 302 may also include a brush channel 304 configured to allow a portion of the rotary brush 134 to pass through the at least one basket 302. In an exemplary aspect, the elongate member of the rotary brush 134 may be arranged to extend through the brush channel 304 arranged at opposing ends of the at least one basket 302 and allow the rotary brush 134 to be arranged in an interior of the at least one basket 302 during cleaning while the elongate member of the rotary brush 134 passes through the brush channel 304 and operatively engages the rotatable mounting brackets 130. The basket assembly may also include a utensil tray 306 configured to be used with utensils or other elongate articles to be cleaned that may be inserted and releasably retained within the array of openings formed within the utensil tray 306 during cleaning. In an exemplary aspect, the utensil tray 306 may include a plurality of openings therethrough.

Referring to FIG. 6, the portable golf club washing device 100 may be configured with alternative cleaning configurations that extend the functionality beyond golf club cleaning applications. The basket assembly may provide an interchangeable alternative to the shelf assembly 124, allowing the portable golf club washing device 100 to accommodate various items including kitchenware, hardware tools, jewelry, and other small articles that may benefit from automated cleaning processes. The basket assembly may utilize the same structural foundation as the shelf assembly 124, including the at least one support 116 positioned on the housing base 104 and the at least one shelf bracket 120 providing releasable coupling mechanisms. The interchangeable nature between the shelf assembly 124 and the basket assembly may allow users to readily convert the portable golf club washing device 100 from golf club cleaning applications to general-purpose cleaning applications through simple removal and replacement of the cleaning components.

The at least one basket 302 may serve as a support structure configured to support various items to be washed, replacing the cradle 126 and shaft bracket 128 arrangement used for golf club cleaning. The at least one basket 302 may include a perforated platform with multiple circular openings arranged in a grid pattern, allowing cleaning fluid to flow through the at least one basket 302 and around the items contained within. The perforated design of the at least one basket 302 may facilitate thorough cleaning by enabling the cleaning fluid to reach all surfaces of the items being cleaned while preventing smaller items from falling through the openings. In some aspects, the at least one basket 302 may be manufactured in various sizes ranging from very small configurations suitable for jewelry cleaning to large configurations capable of accommodating substantial kitchenware or hardware tools. The at least one basket 302 may be coupled to the at least one support 116 through the at least one shelf bracket 120, maintaining the same releasable coupling mechanism utilized by the shelf assembly 124.

The utensil tray 306 may provide an additional support structure configured to support elongated items to be washed, such as kitchen utensils, small tools, or other articles that may benefit from vertical positioning during cleaning operations. As shown in FIG. 6, the utensil tray 306 may be positioned above the at least one basket 302 and may include an array of openings configured to receive and retain portions of elongated articles during cleaning. The utensil tray 306 may function as a retention mechanism configured to releasably retain portions of the items to be washed, preventing movement during cleaning cycles while allowing cleaning fluid to circulate around the retained articles. The openings in the utensil tray 306 may be dimensioned to accommodate various diameters of utensil handles, tool shafts, or other elongated articles, providing secure retention without restricting fluid flow. The utensil tray 306 may be removably positioned on the at least one basket 302, allowing for flexible configuration of the cleaning interior 156 based on the specific items being cleaned.

The basket assembly configuration may maintain compatibility with the rotatable mounting brackets 130 and the rotary brush 134 disclosed for golf club cleaning applications. The rotary brush 134 may include an elongate member with opposing ends configured to operatively engage the at least one pair of rotatable mounting brackets 130 arranged at opposing interior sidewalls 164 of the housing 102. In some aspects, the at least one basket 302 may include the brush channel 304 configured to allow the elongate member of the rotary brush 134 to pass through the at least one basket 302, enabling the rotary brush 134 to provide mechanical cleaning action within the cleaning interior 156 formed by the housing 102 and housing lid 108. The motor operatively connected to the at least one pair of rotatable mounting brackets 130 may be configured to rotate the rotary brush 134, providing agitation and scrubbing action for items contained within the at least one basket 302 or retained by the utensil tray 306. The user input interface 148 may remain operatively connected to both the pump 136 and the motor, allowing users to control the action of the pump 136 and the rotation of the rotary brush 134 during cleaning operations regardless of whether the shelf assembly 124 or basket assembly configuration is utilized.

The flow channel 142 may continue to provide fluid circulation around the basket assembly in the same manner as disclosed for the shelf assembly 124 configuration. The flow channel 142 may include an inlet in fluid communication with the pump 136 and an outlet, with the flow channel 142 arranged around at least a portion of an interior perimeter of the housing 102. The flow channel 142 may further include a fluid conduit that directs cleaning fluid toward the at least one basket 302 and utensil tray 306, ensuring thorough coverage of items being cleaned. In configurations where multiple baskets 302 are utilized, the support structure may include an array of support structures, with corresponding retention mechanisms including an array of retention mechanisms associated with the array of support structures. The at least one pair of rotatable mounting brackets 130 and the rotary brush 134 may be arranged between an adjacent pair of support structures of the array of support structures, providing mechanical cleaning action across multiple cleaning zones within the cleaning interior 156. The modular nature of the basket assembly may allow the portable golf club washing device 100 to be scaled for various applications, from small jewelry cleaning operations to larger kitchenware or hardware tool cleaning requirements.

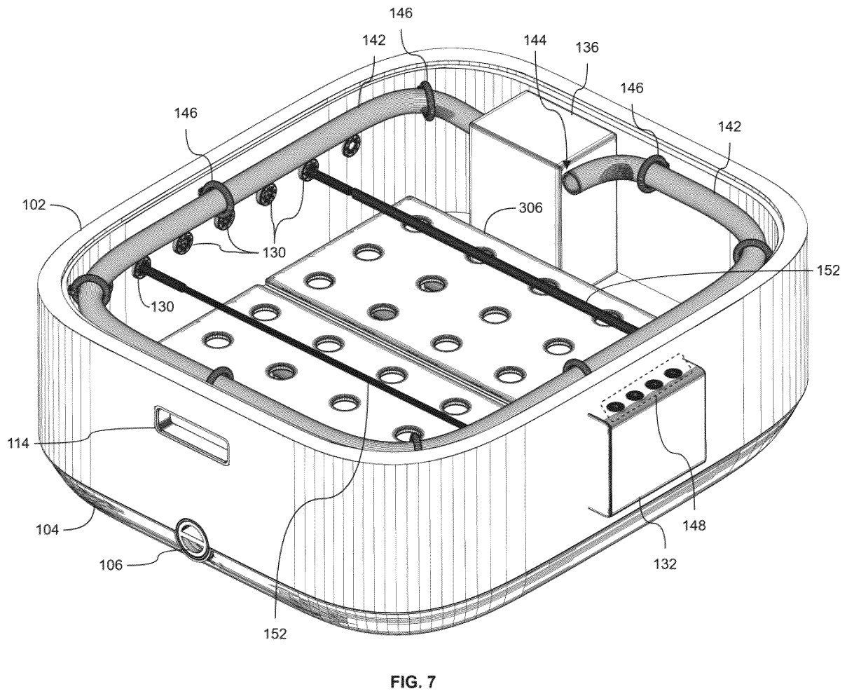

FIG. 7 illustrates an exploded perspective view of the portable golf club washing device 100 configured with alternative cleaning components that demonstrate the modular design capabilities of the device. The exploded view depicts the housing 102 with the housing base 104 positioned at the bottom of the assembly, with the drain 106 formed within the housing base 104 to facilitate fluid removal from the cleaning interior. The handle 114 may be formed as an integral component of the housing 102, providing enhanced portability for transport and positioning of the portable golf club washing device 100. In some aspects, the housing lid 108 may include removable handles that provide additional gripping surfaces for enhanced portability and storage convenience, allowing users to easily maneuver the housing lid 108 during assembly and disassembly operations.

The internal configuration shown in FIG. 7 demonstrates the arrangement of the rotatable mounting brackets 130 positioned at opposing interior sidewalls 164 of the housing 102. An elongate member 152 may be configured with opposing ends that operatively engage the rotatable mounting brackets 130, allowing the elongate member 152 to be rotatably supported within the cleaning interior formed when the housing lid 108 may be reversibly coupled to the housing 102. The rotary brush 134 may include the elongate member 152 as a central support structure, with the elongate member 152 extending across the width of the housing 102 between the rotatable mounting brackets 130. The modular design of the rotatable mounting brackets 130 and elongate member 152 may accommodate various cleaning assemblies, including the shelf assembly 124 for golf club cleaning applications and alternative configurations such as the utensil tray 306 depicted in the exploded view.

The pump 136 may be positioned within the housing 102 and may include a pump inlet 138 arranged at a lower portion of an interior of the housing 102 to facilitate fluid intake from the cleaning interior. A pump outlet 140 may be provided in fluid communication with the flow channel 142, allowing pressurized fluid to be directed through the flow channel 142 during cleaning operations. The flow channel 142 may be arranged around at least a portion of an interior perimeter of the housing 102 and may include multiple flow channel outlets 144 positioned to direct cleaning fluid toward articles positioned within the cleaning interior. Fluid channel brackets 146 may be arranged along the flow channel 142 to provide structural support and maintain proper positioning of the flow channel 142 relative to the interior sidewalls 164 of the housing 102. The flow channel 142 may further include a fluid conduit that directs pressurized cleaning fluid from the pump outlet 140 through the flow channel 142 and out through the flow channel outlets 144.

As shown in FIG. 7, the utensil tray 306 may be positioned above the internal fluid circulation components and may be supported by the at least one support 116 through the at least one shelf bracket 120. The utensil tray 306 may provide an alternative cleaning configuration that allows the portable golf club washing device 100 to accommodate various articles beyond golf clubs, including kitchen utensils, small tools, jewelry, and other elongated articles that may benefit from vertical positioning during cleaning cycles. The modular nature of the cleaning assemblies may allow users to readily interchange between the shelf assembly 124 for golf club cleaning and alternative configurations such as the utensil tray 306 for general-purpose cleaning applications. An interior floor 160 of the housing 102 may be configured to retain a volume of fluid along with a portion of the interior sidewalls 164 of the housing 102, forming a fluid reservoir that may be accessed by the pump inlet 138 during operation.

The controller 132 and user input interface 148 may be integrated into the housing 102 to provide a control station for managing pump and motor operations across different cleaning configurations. The controller 132 may be operatively connected to the pump 136 and configured to control the action of the pump 136 based on user inputs received through the user input interface 148. In some aspects, the controller 132 may also be operatively connected to a motor that may be configured to rotate the rotatable mounting brackets 130, thereby providing rotational motion to the elongate member 152 and any cleaning implements attached thereto. The user input interface 148 may be operatively connected to both the pump 136 and the motor, allowing users to independently control fluid circulation and mechanical cleaning actions during operation. Electronics associated with the controller 132 and user input interface 148 may be housed within exterior sidewalls 162 of the housing 102 for protection and space efficiency, preventing exposure to cleaning fluids while maintaining accessibility for user operation.

The portable golf club washing device 100 may be configured to operate with wireless or battery power as an alternative to wired power options, providing enhanced portability for use in locations where electrical connections may not be readily available. The modular design demonstrated in FIG. 7 may allow the same housing 102, pump 136, flow channel 142, and control systems to accommodate different cleaning assemblies through simple removal and replacement of the internal support structures. The reversible coupling between the housing lid 108 and the housing 102 may form the cleaning interior when assembled, with the at least one top opening 110 of the housing lid 108 being configured to receive various articles depending on the particular cleaning assembly installed within the housing 102. The detachable housing base 104 may facilitate maintenance and cleaning of the portable golf club washing device 100, allowing access to internal components and thorough cleaning of the interior surfaces after use.

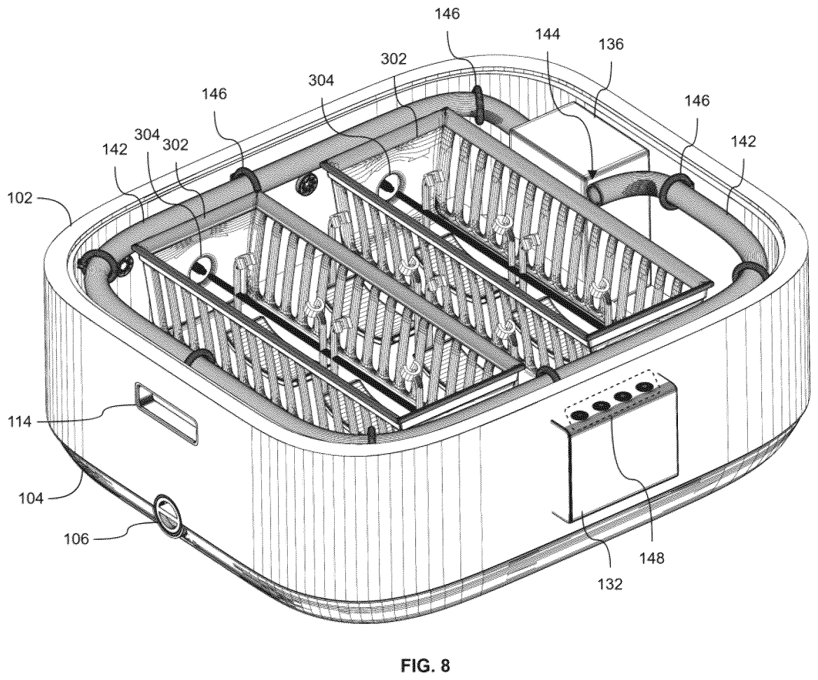

FIG. 8 illustrates a perspective view of the portable golf club washing device 100 configured with the basket assembly in an assembled state, demonstrating the integration of the brush channel 304 with the rotary brush 134 system. The housing 102 may be assembled with the housing base 104 positioned at the bottom of the device, with the drain 106 formed within the housing base 104 to facilitate fluid removal after cleaning operations. The handle 114 may be formed as an integral component of the housing 102, providing enhanced portability for users who may need to transport the portable golf club washing device 100 between different locations. The at least one basket 302 may be positioned within the cleaning interior formed when the housing lid 108 may be reversibly coupled to the housing 102, with the brush channel 304 extending through the at least one basket 302 to accommodate the elongate member 152 of the rotary brush 134.

The brush channel 304 may provide a critical structural feature that allows the rotary brush 134 to maintain functionality while the at least one basket 302 may be positioned within the cleaning interior. The elongate member 152 of the rotary brush 134 may extend through the brush channel 304, with opposing ends of the elongate member 152 configured to operatively engage the rotatable mounting brackets 130 arranged at opposing interior sidewalls 164 of the housing 102. The rotatable mounting brackets 130 may include gear connections at connection points for mechanical operation, allowing precise control of rotational motion transmitted to the elongate member 152 during cleaning cycles. In some aspects, the rotatable mounting brackets 130 may be compressed or extended to accommodate different configurations of articles positioned within the at least one basket 302, providing adjustable positioning that may optimize cleaning effectiveness for various item sizes and shapes. The gear connections may facilitate smooth rotation while maintaining structural integrity under the operational loads generated during cleaning operations.

The rotary brush 134 may include bristles 154 arranged along the elongate member 152, with the bristles 154 positioned to provide mechanical cleaning action for articles contained within the at least one basket 302. The bristles 154 may be made from different materials to accommodate various cleaning needs, with softer bristle materials being utilized for delicate articles such as jewelry or specialized kitchenware, and firmer bristle materials being employed for more robust items such as hardware tools or heavily soiled utensils. In some aspects, the rotary brush 134 may include adjustable bristle rods that may be modified for different cleaning requirements, allowing users to customize the mechanical cleaning action based on the specific articles being washed. The adjustable bristle rods may provide varying degrees of cleaning intensity, with the bristles 154 being repositioned or replaced to accommodate different cleaning applications while maintaining compatibility with the brush channel 304 configuration.

As shown in FIG. 8, the flow channel 142 may be arranged around at least a portion of an interior perimeter of the housing 102, with the flow channel 142 configured to provide fluid distribution for different types of items positioned within the at least one basket 302. The pump 136 may be arranged within the housing 102 and may include the pump inlet 138 arranged at a lower portion of an interior of the housing 102, allowing the pump 136 to draw fluid from a reservoir formed by the interior floor 160 and a portion of the interior sidewalls 164 of the housing 102. The pump outlet 140 may be in fluid communication with the flow channel 142, directing pressurized cleaning fluid through the flow channel 142 and out through multiple flow channel outlets positioned along the flow channel 142. The flow channel 142 may be supported by fluid channel brackets positioned along the interior perimeter of the housing 102, maintaining proper positioning of the flow channel 142 relative to the at least one basket 302 and the articles contained therein.

The controller 132 and the user input interface 148 may be positioned on an exterior wall of the housing 102, providing operational control for both the pump 136 and a motor operatively connected to the rotatable mounting brackets 130. The user input interface 148 may be operatively connected to the pump 136 and configured to control an action of the pump 136, allowing users to initiate a flow of fluid through the pump 136 and the flow channel 142 during cleaning operations. In some aspects, the user input interface 148 may also be operatively connected to the motor and configured to control an action of the motor, enabling users to initiate a rotation of the rotary brush 134 independently of the fluid circulation system. The dual control capability may allow users to operate the mechanical cleaning action provided by the rotary brush 134 and the fluid circulation system either simultaneously or independently, depending on the specific cleaning requirements of the articles positioned within the at least one basket 302.

The at least one basket 302 may include a perforated platform configuration that allows cleaning fluid to flow through the at least one basket 302 and around articles contained within, while the brush channel 304 may provide clearance for the rotary brush 134 to operate within the cleaning interior without interference from the basket structure. The brush channel 304 may be dimensioned to accommodate the elongate member 152 and the bristles 154 of the rotary brush 134, allowing the rotary brush 134 to provide mechanical agitation and scrubbing action for articles positioned within the at least one basket 302. In configurations where multiple baskets 302 may be utilized, the brush channel 304 may extend through each basket in the array, allowing the rotary brush 134 to provide cleaning action across multiple cleaning zones within the cleaning interior. The integration of the brush channel 304 with the at least one basket 302 may enable the portable golf club washing device 100 to accommodate various articles including kitchenware, hardware tools, jewelry, and other items that may benefit from combined fluid circulation and mechanical cleaning action.

The housing base 104 may include the drain 106 configured to release fluid from an interior of the housing 102 to an exterior of the housing 102, facilitating efficient fluid management after cleaning cycles may be completed. The drain 106 may be positioned at a lowest point of the interior floor 160, allowing complete drainage of cleaning fluid from the cleaning interior formed by the housing 102 and the housing lid 108. The at least one top opening 110 of the housing lid 108 may be configured to receive various articles depending on the particular basket configuration utilized, with the at least one top opening 110 providing access for inserting and removing articles from the at least one basket 302 during operation. The modular design demonstrated in FIG. 8 may allow the same housing 102, pump 136, flow channel 142, and rotary brush 134 system to accommodate different cleaning applications through the interchangeable basket assembly configuration, providing versatility for cleaning various types of articles while maintaining the integrated brush channel 304 functionality.

Various other types of shelves and assemblies may be contemplated for use in the portable golf club washing device 100.

In some aspects, the portable golf club washing device 100 may also include a bristle cleaning assembly configured to contact and clean surfaces of a golf club head in the portable golf club washing device 100. In some aspects, the portable golf club washing device 100 may include at least one pair of rotatable mounting brackets 130 arranged at opposing interior sidewalls of the housing 102. In some aspects, the rotatable mounting brackets 130 may be arranged within an interior cavity of the walls forming the housing 102 such that the rotatable mounting brackets 130 are relatively hidden from view. The rotatable mounting brackets 130 may include an array of the rotatable mounting brackets 130 arranged along opposing interior wall surfaces of the housing 102. The rotatable mounting brackets 130 may operatively connected to a controller 132 and a motor (not shown), which provide a rotating action of the rotatable mounting brackets 130. In some aspects, the motor may be housed within the same housing of the controller 132. In other aspects, the motor may be distributed within further structures of the housing 102 or may be arranged at a separate location within, outside, or inside the housing 102. The motor may be operatively coupled to the rotatable mounting brackets 130 through any suitable variety of transmission elements or other power transmission components that transmit, modify, or control the motion generated by the motor to effectively drive and rotate the rotatable mounting brackets 130. The rotatable mounting brackets 130 may provide bi-directional rotation and may be selectively operated by the controller 132 to rotate in any direction for any time according to selectable cleaning modes and protocols associated with the portable golf club washing device 100. The array of the rotatable mounting brackets 130 may also be operatively connected to each other so the rotatable mounting brackets 130 and the motor may coordinate action of the rotatable mounting brackets 130.

The rotatable mounting brackets 130 may be operatively connected to a controller 132 and a motor (not shown), which provide a rotating action of the rotatable mounting brackets 130. In some aspects, the motor may be housed within the same housing of the controller 132. In other aspects, the motor may be distributed within further structures of the housing 102 or may be arranged at a separate location within, outside, or inside the housing 102. The motor may be provided as any suitable motor capable of generating rotational motion, including but not limited to electric motors, servo motors, stepper motors, or brushless DC motors. In an exemplary aspect, the motor may be a low-voltage DC motor configured to operate on battery power for enhanced portability of the portable golf club washing device 100. The motor may be rated for continuous operation and may include variable speed control capabilities to accommodate different cleaning requirements and rotary brush 134 configurations.

The motor may be operatively coupled to the rotatable mounting brackets 130 through various transmission mechanisms, including direct drive connections, gear reduction systems, belt drive systems, or chain drive systems. In some aspects, the transmission mechanism may include a gear train configured to reduce the rotational speed of the motor while increasing the torque delivered to the rotatable mounting brackets 130, thereby providing optimal cleaning action for the rotary brush 134. The gear reduction ratio may be selected based on the desired rotational speed of the rotary brush 134 and the torque requirements for effective cleaning of golf club heads or other articles positioned within the cleaning interior 156.

In aspects where the motor is housed within the same housing as the controller 132, the combined motor-controller assembly may be positioned within the exterior sidewalls 162 of the housing 102 to protect the electrical components from exposure to cleaning fluids while maintaining accessibility for maintenance and service. The motor-controller assembly may be sealed within a waterproof enclosure to prevent fluid ingress during cleaning operations. In alternative aspects where the motor is distributed within further structures of the housing 102, the motor may be positioned within the interior sidewalls 164 of the housing 102, with appropriate sealing and protection mechanisms to prevent contamination from cleaning fluids. The motor may also be positioned within the housing base 104, providing a low center of gravity for enhanced stability during operation.

Where the motor is arranged at a separate location outside the housing 102, the motor may be connected to the rotatable mounting brackets 130 through external drive shafts, flexible couplings, or other suitable power transmission components that extend through sealed openings in the housing 102. This external motor configuration may facilitate easier maintenance and service of the motor while reducing the internal volume occupied by drive components within the cleaning interior 156. The external motor may be mounted on a separate base or support structure that may be positioned adjacent to the portable golf club washing device 100 during operation.

The controller 132 may be configured to provide precise control of motor operation, including variable speed control, directional control, and programmable operation cycles. The controller 132 may include motor control circuitry such as pulse width modulation (PWM) controllers, motor driver circuits, and feedback control systems to maintain consistent rotational speed and torque output regardless of varying load conditions encountered during cleaning operations. In some aspects, the controller 132 may include current sensing capabilities to monitor motor performance and detect potential issues such as motor overload or mechanical binding of the rotary brush 134 system.

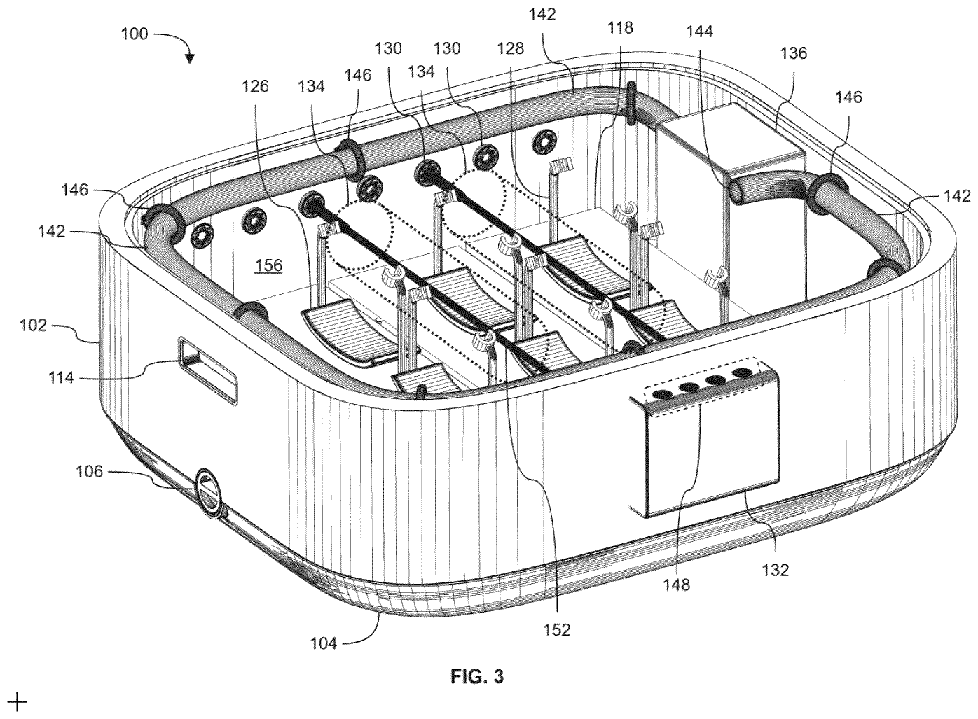

FIG. 3 depicts a perspective view of an interior of the portable golf club washing device 100 according to the present disclosure. Corresponding rotatable mounting brackets 130 on opposing interior surfaces of the housing 102 may be detachably and operatively coupled with a rotary brush 134. The rotary brush 134 may include an elongate member 152 extending at least a length of the rotary brush 134 and defining a longitudinal axis of the rotary brush 134. The elongate member 152 of the rotary brush 134 may be dimensioned such that each of the elongate member may operatively couple with each of a corresponding pair of the rotatable mounting brackets 130. Accordingly, where a corresponding pair of the rotatable mounting brackets 130 are engaged with the rotary brush 134, a rotation of the rotatable mounting brackets 130 enacts a corresponding rotation of the rotary brush 134.

In an exemplary aspect, the rotary brush 134 includes an array of the rotary brush 134, with the array of the rotary brush 134 corresponding to the array of corresponding pairs of the rotatable mounting brackets 130. The rotary brush 134 may be arranged to extend along side and adjacent to the cradle 126 and corresponding shaft bracket 128 configured to releasably retain the golf club head and golf club shaft such that the rotary brush 134 may have an operational range of cleaning that acts primarily upon a face or back of the golf club head. Where more than one of the rotary brush 134 are arranged on opposing adjacent sides of the cradle 126 and the shaft bracket 128, one of the rotary brush 134 may act upon the face side of the golf club head and the other rotary brush 134 may act upon the back side of the golf club head.

The rotary brush 134 may be provided as various type of brushes, including bristle and/or cloth style brushes with materials of varying degrees of stiffness. In some aspects, the rotary brush 134 may include soft, medium, stiff bristles, or combinations thereof. Exemplary materials for soft bristles include nylon or natural fibers. Exemplary materials for medium stiff bristles include polypropylene or nylon blends. Exemplary materials for hard stiffness bristles may include various wire brushes. In some aspects, the rotary brush 134 may include cloth strips. The rotary brush 134 may also include various brush shapes, including disc or wheel, cup, cylindrical, or combinations thereof. The above described aspects of the rotary brush 134 are exemplary and not limited to disclosed aspects and may include other bristles and brush types that may be suitable for cleaning golf club heads in the portable golf club washing device 100. Accordingly, the rotary brush 134 may be interchangeable for use in the portable golf club washing device 100 according to the desired cleaning effect on the golf club head. Due to the detachable operative coupling of the rotary brush 134 with the rotatable mounting brackets 130, more than one type of rotary brush 134 may be employed at the same time within the portable golf club washing device 100. The rotary brush 134 may also be controller by the controller 132 to rotate any selectable direction for any selectable speed and period of time as determined by a desired cleaning or protocol employed in the portable golf club washing device 100.

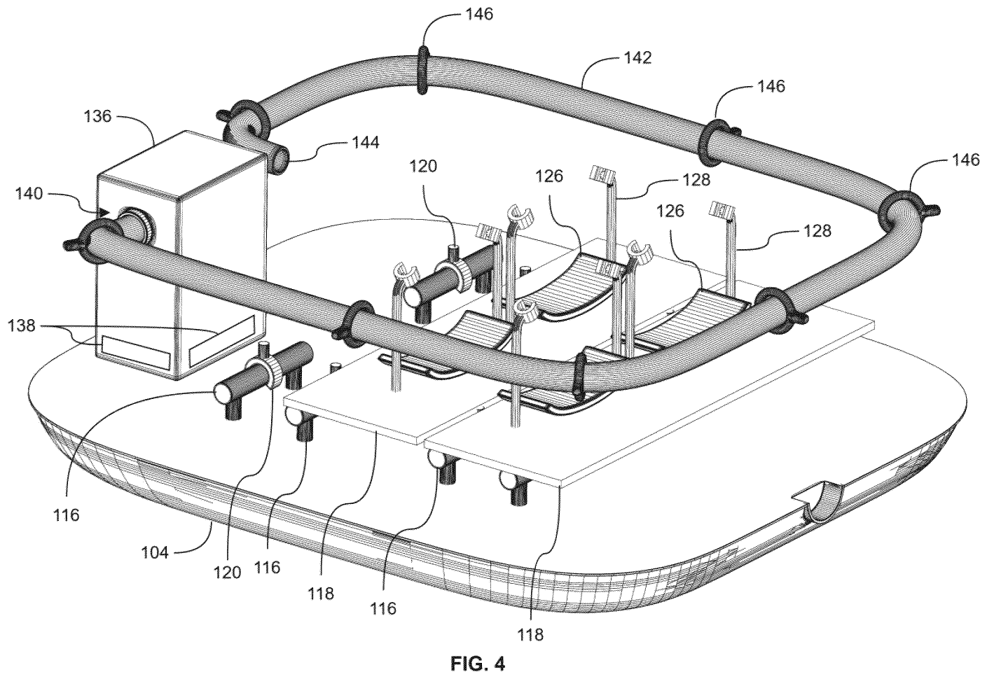

As depicted in FIG. 4, the portable golf club washing device 100 may further include a pump 136 configured to create a flow of water by moving water from a pump inlet 138 to a pump outlet 140. The pump 136 may be provided as any suitable pump to be arranged in an interior, exterior, or within the walls of the housing 102. In an exemplary aspect, the pump 136 is coupled to an interior wall of the housing 102, with the pump inlet 138 arranged at a lower portion of the pump 136. The pump inlet 138 is preferably arranged at a lower portion of the pump 136 that is below a level of fluid when the portable golf club washing device 100 is in use. In operation, the interior of the portable golf club washing device 100 is filled with a volume of fluid such that the volume of fluid covers and occupies the area of the interior of the portable golf club washing device 100 where the pump inlet 138 is arranged.

In an exemplary aspect, the pump outlet 140 is in fluid communication with a flow channel inlet 142. In some aspects, a flow channel 142 is provided to be in fluid communication with the pump 136 and the volume of fluid present in the portable golf club washing device 100 during use. The pump 136 may cause a flow of the fluid from the pump outlet 140 through the flow channel 142 to facilitate distribution of the fluid to the golf club heads to be cleaned. In operation, the fluid flows from the pump outlet 140 to the flow channel 142 through the flow channel 142 and to an flow channel outlet 144 to be provided to an interior of the portable golf club washing device 100 and the interior cleaning chamber of the golf club heads releasably retained in the cradle 126 and the shaft bracket 128.

In some aspects, the flow channel 142 may be arranged within an interior of the walls of the housing 102 and may be formed through cavities or other suitable channels allowing flow of the fluid. In an exemplary aspect, the flow channel 142 includes a fluid conduit arranged around an upper interior perimeter of the housing 102. Where the flow channel 142 is provided as a separate structure distinct from the housing 102, the flow channel 142 may be coupled to the housing 102 via fluid channel brackets 146.

In some aspects, the flow channel 142 may include more than one flow channel outlet 144. The flow channel outlet 144 may be arranged at any one or more locations through the flow channel 142 to provide a plurality of outlets for providing the fluid to the interior cleaning chamber. In some aspects, the flow channel outlet 144 may be provided as an orifice from an interior of the walls of the housing 102 to the interior cleaning chamber. In an exemplary aspect, the flow channel outlet 144 is provided as a simple outlet for providing fluid to the interior cleaning chamber. In some aspects, the flow channel 142 may be provided on an interior lower surface of the housing lid 108 to provide fluid vertically downward to the interior cleaning chamber. In some aspects, the flow channel 142 may be distributed among various structures of the housing 102 and the housing lid 108 to provide for a plurality of the flow channel outlet 144 among various locations leading to the interior cleaning chamber. The flow channel outlet 144 may be arranged generally towards an area of the interior cleaning chamber centrally located among the interior sidewalls of the housing 102 and centrally located between the interior floor of the housing 102 and a bottom of the housing lid 108 defining the ceiling of the interior cleaning chamber. In some aspects, the flow channel outlet 144 may be arranged to direct fluid to one or more specific locations within the interior cleaning chamber, preferably toward locations designated for golf club heads supported by the cradle 126. The flow channel outlet 144 may include the plurality of the flow channel outlet 144, with one or more of the plurality of the flow channel outlet 144 arranged to direct fluid onto various faces of the golf club heads supported by the cradle 126. In an exemplary aspect, where the cradle 126 and the corresponding shaft bracket 128 are arranged in an array, the flow channel outlet 144 may include a corresponding array of the flow channel outlet 144 arranged to direct fluid directly onto the golf club heads supported by the array of the cradle 126.

Though not shown, the portable golf club washing device 100 may further include fluid distribution structures arranged at the flow channel outlet 144 to aid in distributing the fluid to the articles to be cleaned and the rotary brush 134. In some aspects, these fluid distribution structures may also serve to distribute a cleaning agent (e.g., soap) with the flow of fluid from the flow channel outlet 144. In an exemplary aspect, a soap reservoir with a distribution structure may be in fluid communication with the flow channel 142 and/or the flow channel outlet 144 to provide distribution of the soap to the interior cleaning chamber.

The fluid distribution structures may include various configurations designed to optimize fluid delivery and cleaning effectiveness within the cleaning interior 156. In some aspects, the fluid distribution structures may include spray nozzles positioned at the flow channel outlet 144, with each spray nozzle configured to direct pressurized fluid in a specific spray pattern toward the articles being cleaned. The spray nozzles may be adjustable to accommodate different spray angles and flow rates, allowing customization of the cleaning action based on the particular articles positioned within the cleaning interior 156. In an exemplary aspect, the spray nozzles may include multiple orifice sizes to provide varying degrees of fluid pressure and coverage, with smaller orifices generating higher pressure streams for stubborn debris removal and larger orifices providing broader coverage for general cleaning applications.

The fluid distribution structures may also include diffuser elements configured to create turbulent flow patterns that enhance cleaning effectiveness around complex geometries of golf club heads or other articles. The diffuser elements may be positioned downstream of the flow channel outlet 144 and may include internal baffles, flow directors, or venturi structures that create swirling or oscillating fluid motion. In some aspects, the diffuser elements may be removable and interchangeable, allowing users to select different flow patterns based on the specific cleaning requirements of the articles being washed. The diffuser elements may be manufactured from corrosion-resistant materials such as stainless steel or engineered plastics to withstand repeated exposure to cleaning fluids and maintain consistent performance over extended use periods.

In aspects where cleaning agents are distributed through the fluid distribution structures, the soap reservoir may include a variable dispensing mechanism configured to control the concentration of cleaning agent mixed with the fluid flow. The soap reservoir may be positioned within the housing 102 or may be provided as an external reservoir connected to the flow channel 142 through a dedicated soap inlet line. The distribution structure associated with the soap reservoir may include a metering valve or proportioning system that automatically mixes predetermined ratios of cleaning agent with the fluid flow based on the selected cleaning cycle or user preferences. In some aspects, the soap reservoir may include multiple compartments configured to hold different types of cleaning agents, with the distribution structure including selector valves that allow users to choose specific cleaning agents for different cleaning applications.

The soap reservoir may further include a refillable cartridge system that facilitates easy replacement or refilling of cleaning agents without requiring disassembly of the portable golf club washing device 100. The refillable cartridge system may include quick-connect fittings that provide leak-proof connections between the soap reservoir and the distribution structure while allowing rapid cartridge replacement. In an exemplary aspect, the refillable cartridge system may include color-coded cartridges corresponding to different cleaning agent types, such as degreasing agents for heavily soiled articles, gentle cleaners for delicate surfaces, or specialized formulations for specific materials such as chrome, stainless steel, or composite materials commonly found in golf club construction.

The distribution structure may also include mixing chambers positioned between the soap reservoir and the flow channel outlet 144, with the mixing chambers configured to ensure thorough blending of cleaning agents with the fluid flow before distribution to the cleaning interior 156. The mixing chambers may include static mixing elements or dynamic mixing mechanisms that create turbulent flow conditions to achieve homogeneous mixing of cleaning agents and fluid. In some aspects, the mixing chambers may include temperature control elements that maintain optimal cleaning agent effectiveness by preventing degradation due to temperature extremes during operation.

The portable golf club washing device 100 may further include a fluid inlet configured to be fluidly coupled with a fluid reservoir or other fluid supply conduit, a water hose for example. In this manner, pump 136 and the pump inlet 138 of the portable golf club washing device 100 may operate to simply receive fluid from an external fluid source and not recycle fluid from the interior cleaning chamber within the housing 102. In some aspects, the portable golf club washing device 100 may include a used fluid outlet that operates to filter out dirt and debris in the fluid after the fluid has been provided by the flow channel outlet 144 and distributed to the golf club heads.

The portable golf club washing device 100 may further include the controller 132 operatively connected to both the pump 136 and the rotatable mounting brackets 130 to provide a cleaning action of the portable golf club washing device 100. In operation, the controller 132 may provide a flow signal to the pump 136 to control a flow of fluid through the pump 136 and the flow channel 142 to selectively provide fluid to the interior cleaning chamber. In some aspects, the controller 132 may provide for selectable rates, volumes, and pressure associated with the pump 136 and flow of fluid through the flow channel 142 to the flow channel outlet 144. In further aspects, the controller 132 may provide a rotation signal to the rotatable mounting brackets 130 to control a rotation of the rotatable mounting brackets 130, and thus a corresponding rotation of the rotary brush 134 operatively engaged with the rotatable mounting brackets 130. In some aspects, the controller 132 may provide for selectable rates and amplitudes of rotation of the rotatable mounting brackets 130. In some aspects, the controller 132 may provide for a cleaning signal that operatively controls both the pump 136 and the rotatable mounting brackets 130 to cooperatively engage with rotation of the rotary brush 134 and flow of fluid through the flow channel 142 and flow channel outlet 144 to provide for a cleaning of the golf club head. In some aspects, the controller 132 may provide for selectable and programmable cleaning cycles associated with the portable golf club washing device 100 such that the rotation of the rotatable mounting brackets 130 and the flow associated with the pump 136 are fully customizable to provide for selectable cleaning cycles associated with the portable golf club washing device 100.

In some aspects, the portable golf club washing device 100 may include a user input interface 148 operatively coupled to the controller 132. The user input interface 148 may provide inputs to the controller 132 to control the action of the pump 136 and the rotatable mounting brackets 130 during cleaning. In an exemplary aspect, the user input interface 148 may be provided as a set of buttons to control the controller 132, which may include a play button, a pause button, a power button, a timer button, or any combination thereof. In some aspects, the user input interface 148 may be provided as a touch interface to provide for certain cleaning protocols associated with the controller 132. In some aspects, the user input interface 148 may provided as an interface of a mobile device operatively associated with the portable golf club washing device 100, including smartphones, a remote, or any other suitable device that may provide wired or wireless transmission of user inputs to the controller 132 to control an action of the portable golf club washing device 100.

In some aspects, the user input interface 148 may include selectable cleaning functions associated with the method 200 of cleaning golf clubs with the portable golf club washing device 100. Some selectable cleaning functions may include an automatic mode, whereby a cleaning cycle of the portable golf club washing device 100 is initiated upon detection of golf club heads supported by the cradle 126 and/or a portion of the golf club shaft releasably retained by the shaft bracket 128. Additional selectable cleaning functions may include various cleaning modes, including cleaning cycles based upon dirtiness levels of the golf clubs, various parameters associated with the action of the pump 136 and/or the rotatable mounting brackets 130, or a combination thereof.

The cleaning cycles based upon dirtiness levels may include a light cleaning mode for golf clubs with minimal surface contamination, a standard cleaning mode for golf clubs with moderate dirt and grass stains, and a heavy-duty cleaning mode for golf clubs with substantial debris accumulation or hardened deposits. The light cleaning mode may utilize reduced pump pressure and shorter rotary brush 134 operation cycles to provide gentle cleaning action suitable for maintaining golf clubs that require only routine maintenance. The standard cleaning mode may employ moderate pump pressure and balanced rotary brush 134 operation to effectively remove typical playing conditions debris while maintaining efficient cleaning cycle times. The heavy-duty cleaning mode may utilize maximum pump pressure and extended rotary brush 134 operation cycles with alternating rotational directions to dislodge stubborn debris and thoroughly clean heavily soiled golf clubs.

The various parameters associated with the action of the pump 136 may include selectable flow rates ranging from low-pressure gentle rinsing to high-pressure debris removal, with intermediate settings providing customizable cleaning intensity based on user preferences and golf club conditions. The pump 136 parameters may also include pulsed flow patterns that alternate between high and low pressure cycles to create dynamic cleaning action that enhances debris removal effectiveness. In some aspects, the pump 136 parameters may include temperature control settings where the portable golf club washing device 100 is configured with heating elements to provide warm fluid circulation for enhanced cleaning effectiveness, particularly for removing organic deposits or temperature-sensitive contaminants.

The various parameters associated with the rotatable mounting brackets 130 may include selectable rotational speeds ranging from slow-speed gentle brushing to high-speed aggressive scrubbing, with variable speed control allowing users to customize the mechanical cleaning action based on the specific cleaning requirements of different golf club head materials and finishes. The rotatable mounting brackets 130 parameters may also include directional control settings that provide clockwise rotation, counterclockwise rotation, or alternating bidirectional rotation patterns to optimize cleaning coverage and prevent debris from becoming trapped in golf club head grooves. In some aspects, the rotatable mounting brackets 130 parameters may include oscillation modes that provide back-and-forth rotational motion within predetermined angular ranges, creating a scrubbing action that may be particularly effective for cleaning golf club head faces and removing debris from groove patterns.

The combination of pump 136 and rotatable mounting brackets 130 parameters may include synchronized operation modes where the pump 136 and rotary brush 134 actions are coordinated to provide optimal cleaning effectiveness. The synchronized operation modes may include a pre-rinse cycle with high pump pressure and stationary rotary brush 134 positioning to remove loose debris, followed by a scrubbing cycle with moderate pump pressure and active rotary brush 134 rotation to provide mechanical cleaning action, and concluding with a final rinse cycle with high pump pressure and stationary rotary brush 134 positioning to remove loosened contaminants. In some aspects, the combination parameters may include alternating cycles where pump 136 operation and rotary brush 134 operation are sequentially activated to prevent interference between fluid flow and mechanical cleaning actions while maximizing the effectiveness of each cleaning mechanism.

In some aspects, the portable golf club washing device 100 may include an ultrasonic transducer configured to create high-frequency vibrations. In use, the ultrasonic transducer may be submerged into the fluid along with an article to be cleaned and may generate a cavitation effect in the fluid. The controller 132 may be operatively coupled to the ultrasonic transducer and configured to control the operation of the ultrasonic transducer.

In some aspects, the portable golf club washing device 100 may include a filtration assembly configured to filter dirt and debris from cleaned articles. The filtration assembly may include at least a filter, a divergent flow channel, and a debris reservoir. The filter may provide for filtering of dirt and debris of various sizes and any debris suspended in the fluid. After the debris has been filtered, the divergent flow channel my direct fluid containing the debris to the debris reservoir, which is separate and distinct from the remaining fluid in circulation throughout the portable golf club washing device 100. In an exemplary aspect, fluid containing debris is diverted from being recycled through the pump inlet 138 to the pump outlet 140 and thus to the flow channel 142.

The disclosed structures of the portable golf club washing device 100 may include any material suitable for the use of the portable golf club washing device 100, including retaining a volume of fluid within the portable golf club washing device 100, supporting various structures of a golf club, interacting with a flow of fluid, and other steps disclosed as part of the method 200 below. In an exemplary aspect, the housing 102, the housing lid 108, the cradle 126, and the shaft bracket 128 may be provided as a suitable polymer material, including plastics, rubber, or other suitable materials. In some aspects, some structures of the portable golf club washing device 100 may be provided as a metal material.

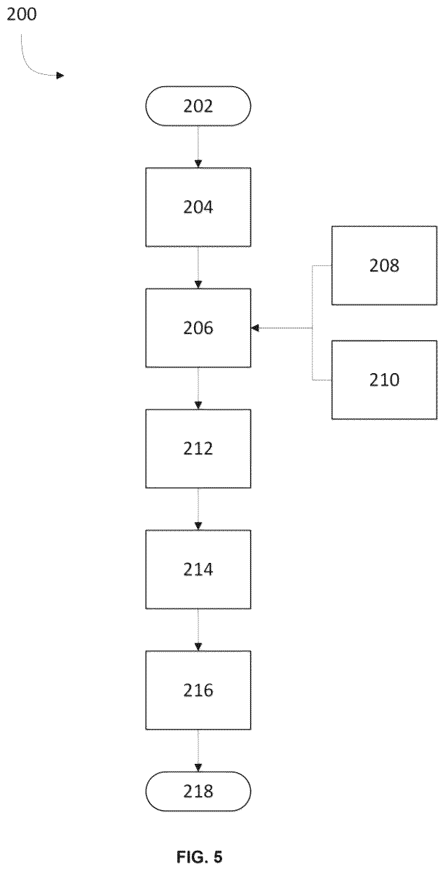

FIG. 5 depicts a method 200 of cleaning golf clubs using the portable golf club washing device 100. In an exemplary aspect, an initial step of the method 200 is a step of providing 202 the portable golf club washing device 100. As disclosed in aspects of the present disclosure above, the portable golf club washing device 100 may include the housing 102, the housing lid 108 reversibly coupled to the housing 102 to define an interior cleaning chamber of the portable golf club washing device 100. The portable golf club washing device 100 may also include the pump 136 in fluid communication with the flow channel 142 and may also include the cradle 126 and corresponding shaft bracket 128 both configured to support different portions of a golf club to be inserted into the portable golf club washing device 100 for cleaning.

In some aspects, the method 200 may continue with a step of filling 204 the portable golf club washing device 100 with a volume of fluid. The step of filling 204 the portable golf club washing device 100 may include providing the fluid to the interior cleaning chamber. In an exemplary aspect, the step of filling 204 the portable golf club washing device 100 includes partially filling the portable golf club washing device 100 with water. In some aspects, the fluid may be any suitable fluid for cleaning golf clubs, including a water and soap mixture, a commercial cleaning fluid, or any fluid capable of flow through the pump 136 and the flow channel 142. In an exemplary aspect, the step of filling 204 the portable golf club washing device 100 with fluid includes filling the portable golf club washing device 100 with enough fluid to cover and occupy the area surrounding the pump inlet 138, so that when the pump 136 creates a flow of the fluid, the pump inlet 138 is sufficiently provided with the fluid.

In some aspects, the method 200 may continue with a step of inserting 206 the golf club head into the portable golf club washing device 100 for cleaning. The step of inserting 206 the golf club into the portable golf club washing device 100 may include a step of resting 208 a portion of the sole, face, heel, toe, back, or a combination thereof onto the cradle 126. The step of inserting 206 the golf club may also include a step of retaining 210 a portion of the golf club shaft in the shaft bracket 128 that corresponds with the cradle 126 on which the golf club head is rested. In an exemplary aspect, the step of inserting 206 the golf club head into the portable golf club washing device 100 includes both resting 208 the golf club head on the cradle 126 and retaining 210 a portion of the golf club shaft in the shaft bracket 128. In some aspects, the steps of resting 208 a portion of the golf club head on the cradle 126 and retaining 210 the portion of the golf club shaft via the shaft bracket 128 may occur separately and without each other to provide the step of inserting 206 the golf club into the portable golf club washing device 100.

In some aspects, the step of inserting 206 the golf club into the portable golf club washing device 100 may occur before, after, or simultaneously with the step of filling 204 the portable golf club washing device 100 with a volume of fluid.

In some aspects, the method 200 may continue with a step of selecting 212 a characteristic or parameter to be associated with the cleaning of the golf clubs. In some aspects, the step of selecting 212 the cleaning settings may be provided through interaction with the user input interface 148 and the controller 132. The step of selecting 212 the cleaning settings may include determining flow rates, times of flow, and pressures of flow to be associated with the pump 136. The step of selecting 212 the cleaning settings may also include determining the direction of rotation, time of rotation, speed of rotation, and any rotation pattern to be associated with the rotatable mounting brackets 130 and the rotary brush 134. In an exemplary aspect, the step of selecting 212 the cleaning settings may include selecting one or more of a preprogrammed cleaning cycle associated with the controller 132 of the portable golf club washing device 100, with the preprogrammed cleaning cycle containing preset actions associated with the pump 136 and the rotatable mounting brackets 130. In some aspects, a user may generate selectable and customizable cleaning cycles to be selectable through the user input interface 148.

The method 200 may also include a step of initiating 214 a cleaning cycle of the golf clubs in the portable golf club washing device 100. In some aspects, the step of initiating 214 the cleaning cycle may be performed without the step of selecting 212 the cleaning settings. In an exemplary aspect, the step of initiating 214 the cleaning cycle may be performed by simply pressing a start button associated with the user input interface 148. The step of initiating 214 the cleaning cycle may be performed by action associated with the user input interface 148. In some aspects, the method 200 may not require an action from a user for the initiating 214 of the cleaning cycle and may instead automatically initiate the cleaning cycle based upon a detected presence of the golf club having been inserted into the portable golf club washing device 100. To this extent, the portable golf club washing device 100 may optionally include one or more sensors configured to detect when a golf club has been inserted into the portable golf club washing device 100, including exemplary sensors of pressure sensors, proximity sensors, and the like.

The method 200 may include a step of cleaning 216 the golf clubs inserted into the portable golf club washing device 100. The step of cleaning 216 may include operating the pump 136 and the rotatable mounting brackets 130 in a coordinated manner to provide an expected cleaning of the golf club. In an exemplary aspect, the cleaning 216 may include initiating a fluid flow cycle to provide an initial wetting of the golf club heads, then a brushing cycle, with or without a flow of the fluid, to agitate surfaces of the golf club head and remove dirt or other surface deposits. The cleaning 216 may exemplarily conclude with a final fluid flow cycle to effectively rinse the golf club head.

The method 200 may continue with a step of removing 218 the golf club from the portable golf club washing device 100. The step of removing 218 the golf club from the portable golf club washing device 100 may include releasing the portion of the golf club shaft from the shaft bracket 128 before removing the golf club from the portable golf club washing device 100.

Various operations, steps or algorithms as described in connection with the controller 132 can be embodied directly in hardware, in a computer program product such as a software module executed by a processor, or in a combination of the two. The computer program product can reside in RAM memory, flash memory, ROM memory, EPROM memory, EEPROM memory, registers, hard disk, a removable disk, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item Band item C.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A portable golf club washing device, comprising:
a housing;
a housing lid reversibly coupled to a top portion of the housing and further comprising at least one top opening configured to receive a golf club head and a portion of a golf club shaft;
a pump;
a flow channel comprising an inlet in fluid communication with the pump and an outlet, the flow channel arranged around at least a portion of an interior perimeter of the housing;
a cradle configured to support the golf club head; and
a bracket configured to releasably retain the portion of the golf club shaft;
wherein the housing lid reversibly coupled to the housing together forms a cleaning interior.

2. The portable golf club washing device of claim 1, further comprising:
at least one pair of rotatable mounting brackets arranged at opposing interior sidewalls of the housing;
a rotary brush comprising an elongate member, opposing ends of the elongate member configured to operatively engage the at least one pair of rotatable mounting brackets; and
a motor operatively connected to the at least one pair of rotatable mounting brackets and configured to rotate the at least one pair of rotatable mounting brackets.

3. The portable golf club washing device of claim 1, further comprising:
a user input interface operatively connected to the pump and configured to control an action of the pump.

4. The portable golf club washing device of claim 2, wherein:
a user input interface operatively connected to the motor and configured to control an action of the motor.

5. The portable golf club washing device of claim 1, wherein:
the pump comprises an inlet arranged at a lower portion of an interior of the housing;
wherein at least an interior floor and a portion of interior sidewalls of the housing are configured to retain a volume of fluid.

6. The portable golf club washing device of claim 5, wherein:
one of the interior sidewalls or the interior floor of the housing comprises a drain configured to release fluid from an interior of the housing to an exterior of the housing.

7. The portable golf club washing device of claim 2, wherein:
the cradle further comprises an array of cradles;
the bracket further comprises an array of brackets associated with the array of cradles; and
the at least one pair of rotatable mounting brackets and the rotary brush are arranged between an adjacent pair of cradles of the array of cradles.

8. The portable golf club washing device of claim 1, wherein:
the flow channel further comprises a fluid conduit.

9. The portable golf club washing device of claim 1, wherein:
the housing further comprises a detachable housing base.

10. A method of using a portable golf club washing device, comprising:
providing the portable golf club washing device, comprising a housing, a housing lid with a top opening, a cradle and a bracket corresponding to the cradle within the housing, a rotatable brush arranged in an operational range of the cradle and the bracket, a motor operatively connected to the rotatable brush, and a pump in fluid communication with a flow channel;
inserting a golf club head and a portion of a golf club shaft into the top opening;
resting the golf club head on the cradle; and
engaging the portion of the golf club shaft with the bracket.

11. The method of claim 10, further comprising:
providing a fluid in the housing; and
initiating, through a user input interface operatively connected to the pump, a flow of the fluid through the pump and the flow channel.

12. The method of claim 10, further comprising:
initiating, through a user input interface operatively connected to the motor, a rotation of the rotatable brush.

13. A portable washing apparatus, comprising:
a housing;
a housing lid reversibly coupled to a top portion of the housing and further comprising at least one top opening configured to receive an item to be washed;
a pump;
a flow channel comprising an inlet in fluid communication with the pump and an outlet, the flow channel arranged around at least a portion of an interior perimeter of the housing;
a support structure configured to support the item to be washed; and
a retention mechanism configured to releasably retain a portion of the item to be washed;
wherein the housing lid reversibly coupled to the housing together forms a cleaning interior.

14. The portable washing apparatus of claim 13, further comprising:
at least one pair of rotatable mounting brackets arranged at opposing interior sidewalls of the housing;
a rotary brush comprising an elongate member, opposing ends of the elongate member configured to operatively engage the at least one pair of rotatable mounting brackets; and
a motor operatively connected to the at least one pair of rotatable mounting brackets and configured to rotate the at least one pair of rotatable mounting brackets.

15. The portable washing apparatus of claim 13, further comprising:
a user input interface operatively connected to the pump and configured to control an action of the pump.

16. The portable washing apparatus of claim 14, wherein:
a user input interface operatively connected to the motor and configured to control an action of the motor.

17. The portable washing apparatus of claim 13, wherein:
the pump comprises an inlet arranged at a lower portion of an interior of the housing;
wherein at least an interior floor and a portion of interior sidewalls of the housing are configured to retain a volume of fluid.

18. The portable washing apparatus of claim 17, wherein:
one of the interior sidewalls or the interior floor of the housing comprises a drain configured to release fluid from an interior of the housing to an exterior of the housing.

19. The portable washing apparatus of claim 14, wherein:
the support structure further comprises an array of support structures;
the retention mechanism further comprises an array of retention mechanisms associated with the array of support structures; and
the at least one pair of rotatable mounting brackets and the rotary brush are arranged between an adjacent pair of support structures of the array of support structures.

20. The portable washing apparatus of claim 13, wherein:
the flow channel further comprises a fluid conduit.
